(19) United States
(12) Patent Application Publication
(10) Pub. No.: US 2016/0168037 A1
(43) Pub. Date: Jun. 16, 2016

(54) THERMAL INTERFACE MATERIAL AND METHOD FOR MANUFACTURING THERMAL INTERFACE MATERIAL

(71) Applicant: Hyundai Motor Company, Seoul (KR)

(72) Inventors: In Chang Chu, Seoul (KR); Yoon Cheol Jeon, Suwon (KR); Hyun Dal Park, Suwon (KR); Gyung Bok Kim, Seoul (KR); Seung Jae Lee, Seoul (KR); In Woong Lyo, Suwon (KR)

(21) Appl. No.: 14/798,515

(22) Filed: Jul. 14, 2015

(30) Foreign Application Priority Data
Dec. 10, 2014 (KR) 10-2014-0177219
May 7, 2015 (KR) 10-2015-0063713

(51) Int. Cl. C04B 35/52; B29C 37/00; B29C 41/20; C09D 153/02; B29C 41/00

(52) U.S. Cl. CPC C04B 35/52; C09D 153/02; B29C 41/003; B29C 41/20; B29C 37/0025; B29K 2105/167

(57) ABSTRACT

A method for manufacturing a thermal interface material is provided. The thermal interface material including a thermal conductive filler, a polymer matrix having an elastic force and applied to the thermal conductive filler, and an insulating coating layer applied to sides of the thermal conductive filler and the polymer matrix may be manufactured by: providing the thermal conductive filler in a plate film form as a filler material forming the thermal conductive filler is dissolved in a solvent; and coating the thermal conductive filler in a plate film form with the polymer matrix. As such, the high heat radiation thermal interface material (a maximum of thermal conductivity of 20 W/mK) may be manufactured in more various thickness than the conventional thermal interface material (a maximum of thermal conductivity of 5 W/mK).

### CROSS-REFERENCE TO RELATED APPLICATION

This application claims the benefit of priority to Korean Patent Application No. 10-2014-0177219, filed on Dec. 10, 2014 and Korean Patent Application No. 10-2015-0063713, filed on May 7, 2015 in the Korean Intellectual Property Office, the disclosure of which is incorporated herein in its entirety by reference.

### TECHNICAL FIELD

The present invention relates to thermal interface material and a method for manufacturing the thermal interface material. The method for manufacturing a thermal interface material may maximize an interface contact using an elastomer material and improve horizontal thermal conductivity by including carbon fiber in a thermal conductive filler.

### BACKGROUND

As a social issue such as suppressing of emission of harmful materials has been raised due to global warming, an interest in a green vehicle has been increased. To keep pace with the situations, optimization of battery performance which may be considered as an engine of the green vehicles may be an important factor in a future vehicle. Accordingly, to achieve the optimization of the battery performance, optimally maintaining environment to drive the battery may be an important factor to improve the performance of the green vehicles.

In the case of an electric vehicle, reliability and stability of a battery system are the most important factor which determines marketability of the electric vehicle. For example, a temperature of the battery system needs to be maintained in a range of about 45° C. to about 50° C., which is an appropriate temperature range to prevent the battery performance from being reduced due to a change in various external temperatures. For this purpose, a need exists for a heat control system for a pouch cell module that is capable of maintaining the appropriate temperature under low temperature environment while having excellent heat radiation performance under a general weather condition.

As a currently developing high heat radiation composite material, a spherical filler and a general carbon-based filler have been used to improve the thermal conductivity. However, with such filler, improvement in characteristics of the thermal conductivity appears at a content of the filler of at least 70% or greater. In this case, moldability may be degraded, and further, the filler may not be formed as a part. Further, the filler may have a limitation of improvement in the horizontal thermal conductivity and may not be applied to parts requiring the horizontal thermal conductivity for specific purpose.

Moreover, to overcome the phenomenon that thermal transfer characteristics due to air and foreign materials at the interface are reduced when heat is transferred between heterogeneous materials, a thermal interface material (TIM) has been applied. However, with the TIM, the horizontal thermal conductivity characteristics may be equal to or less than about 3 W/mK, and thus, sufficient thermal transfer may not occur and the expensive filler may be used.

The contents described as the related art have been provided only for assisting in the understanding for the background of the present invention and should not be considered as corresponding to the related art known to those skilled in the art.

### SUMMARY

The present disclosure has been made to solve the above-mentioned problems occurring in the related arts while maintaining advantages thereof.

In one aspect, the present invention provides a method for manufacturing a thermal interface material. The thermal interface material may be attached to a battery cell, and thus, may maximize thermal conductivity characteristics of the thermal interface material that emits heat of the battery cell and insulating and surface sticking characteristics.

According to an exemplary embodiment of the present invention, a thermal interface material includes a thermal conductive filler, a polymer matrix having an elastic force and applied to the thermal conductive filler, and an insulating coating layer applied to sides of the thermal conductive filler and the polymer matrix, and a method for manufacturing the thermal interface material may include: providing such as extruding the thermal conductive filler in a plate film form; and coating the thermal conductive filler in a plate film form with the polymer matrix. In particular, when the thermal conductive filler is provided, the thermal conductive filler may be formed by dissolving a filler material in a solvent. For example, the solvent for dissolving may be a same component as the polymer matrix.

In another aspect, the present invention provides a thermal interface material. The thermal interface material may comprise: a thermal conductive filler; a polymer matrix configured to have an elastic force and applied to the thermal conductive filler; and an insulating coating layer applied to sides of the thermal conductive filler and the polymer matrix. In particular, the thermal conductive filler may be formed in a film shape and the polymer matrix is coated on the thermal conductive filler. The insulating coating layer may be made of the same component as the polymer matrix.

Further provided is a high heat radiation composite sheet including a thermal interface material, as described herein, that includes a thermal conductive filler and a polymer matrix coated on the thermal conductive filler.

Other aspects of the present invention are disclosed infra.

### BRIEF DESCRIPTION OF THE DRAWINGS

The above and other objects, features and advantages of the present disclosure will be more apparent from the following detailed description taken in conjunction with the accompanying drawings:

FIG. 1 schematically shows a procedure of an exemplary method for manufacturing an exemplary thermal interface material according to an exemplary embodiment of the present invention;

FIG. 2 schematically illustrates a manufacturing state of an exemplary thermal conductive filler according to the method for manufacturing a thermal interface material of FIG. 1;

FIG. 3 shows an enlarged view of an exemplary thermal conductive filler manufactured according to the method for manufacturing a thermal interface material of FIG. 1;

FIG. 4 shown a photograph of an exemplary apparatus for manufacturing the thermal conductive filler according to the method for manufacturing a thermal interface material of FIG. 1;

FIG. 5 schematically illustrates a state in which an exemplary thermal conductive filler is coated with a polymer matrix, according to the method for manufacturing a thermal interface material of FIG. 1;

FIG. 6 is an enlarged view of exemplary main parts of the thermal conductive filler coated with the polymer matrix according to the method for manufacturing a thermal interface material of FIG. 1;

FIG. 7 shows an exemplary apparatus for coating the thermal conductive filler with the polymer matrix according to the method for manufacturing a thermal interface material of FIG. 1;

FIG. shows a photograph of an exemplary apparatus for coating the thermal conductive filler with the polymer matrix according to the method for manufacturing a thermal interface material of FIG. 1;

FIG. 9 schematically illustrates an exemplary thermal interface material manufactured according to the method for manufacturing a thermal interface material of FIG. 1;

FIG. 10 schematically illustrates exemplary surface sticking characteristics between the thermal interface material manufactured according to the method for manufacturing a thermal interface material of FIG. 1 and the thermal interface material manufactured according to the related art; and

FIG. 11 shows a perspective state in which an exemplary thermal interface material manufactured according to the method for manufacturing a thermal interface material of FIG. 1 is mounted in the battery cell and a perspective view of main parts thereof.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Typically, a thermal resistance (fine air layer) may be formed due to surface ruggedness characteristics depending on a contact between heterogeneous materials or alternatively due to surface sticking characteristics, and thus a thermal interface material to effectively transfer heat has been applied. On the other hand, since expensive silver (Ag) and BN (boron nitride) have been used as a filler, the conventional thermal interface material is expensive and hardly shows high-efficiency thermal conductivity characteristics.

Thus, the present invention provides a high radiation thermal interface material that may have insulating characteristics using a carbon-based filler. The high radiation thermal interface material may use a matrix such as elastomer, for example, KRATON, VISTAMAXX, and the like, to perform surface insulating coating to maximize a surface sticking effect and insulating effect. Further, the high radiation thermal interface material may use spray, and the like to perform side insulation and front insulating coating so as to secure withstand voltage characteristics and safety at the time of application.

Exemplary embodiments of the present invention will be described in detail with reference to the accompanying drawings.

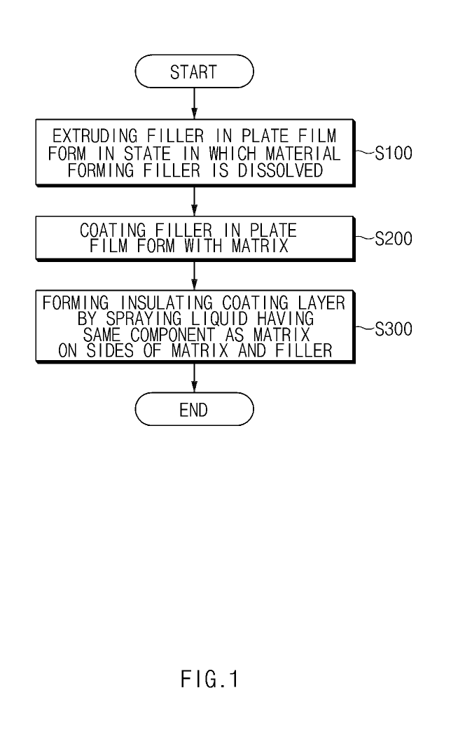

As illustrated in FIG. 1, according to an exemplary embodiment of the present invention, a method for manufacturing a thermal interface material 300, which includes a thermal conductive filler 100, a polymer matrix 200 having an elastic force and applied to a filler 100 and an insulating coating layer applied to sides of the filler 100 and the matrix 200, may include: providing, like pressing or extruding, the thermal conductive filler 100 in a plate film form as a filler material forming the thermal conductive filler 100 is dissolved in a solvent and coating the thermal conductive filler 100 in the plate film form with the polymer matrix 200. The solvent for the thermal conductive filler may be a same component of the polymer matrix. Further, the method for manufacturing the thermal interface material 300 may further include forming the insulating coating layer by spraying a liquid having the same component as the polymer matrix 200 on the sides of the polymer matrix 200 and the thermal conductive filler 100.

The polymer matrix 200 may be made of any one of styrene-based thermoplastic elastomer (TPE), olefin-based thermoplastic elastomer, polyester-based thermoplastic elastomer, and polyamide-based thermoplastic elastomer. Among the styrene-based TPEs, the polymer matrix 200 may also be made of any one of styrene-butadiene-styrene (SBS) block copolymer, styrene-butadiene-ethylene-styrene (SBES) block copolymer, and styrene-isoprene-styrene block copolymer (SIS).

The thermal conductive filler 100 may be at least one selected from the group consisting of carbon black, graphite, expanded graphite granule (EGG), graphene and graphene oxide The thermal conductive filler 100 may be contained at a content of about 20-65 wt %, based on the total weight of the thermal interface material.

Alternatively or additionally, the thermal conductive filler 100 further includes any one selected from the group consisting of carbon nanotube(CNT) and carbon fiber(CF). The CNT or the CF may be embedded in the thermal conductive filler 100 to provide directivity. The CNT or the CF may be contained at a content of about 0-20 wt %, based on the total weight of the thermal interface material.

The thermal interface material 300 manufactured by the method according to an exemplary embodiment of the present invention as described above may use the carbon-based filler 100 (EGG, CF, and the like) to obtain the high heat radiation characteristics and to improve the surface sticking characteristics. In addition, co-block polymer of the elastomer material (KRATON, VISTAMAXX, etc.) may be used as the polymer matrix 200.

To improve the horizontal thermal conductivity, the thermal conductive filler 100 may be manufactured by mixing the CF with a flat-type EGG. In this case, to maximize the effect, about 10 wt % of CF may be mixed with about 50 wt % of EGG. The thermal conductivity characteristics may be variously changed depending on combination of the components.

The following Table 1 shows the vertical and horizontal thermal conductivity values depending on a weight ratio of CF.

TABLE 1

| | CF 0% | CF 1% | CF 5% | CF 10% |
|---|---|---|---|---|
| Horizontal | 2.83 | 2.90 | 4.96 | 8.81 |
| Direction | | | | |
| Vertical Direction | 1.25 | 0.89 | 1.25 | 1.54 |

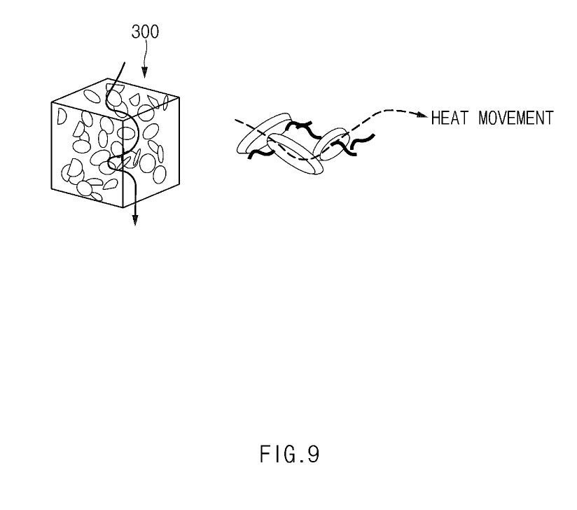

To configure a thin film type thermal interface material 300, the horizontal orientation of the thermal conductive filler 100, in particular, the CF may be improved by a comma coating method, a microcoating method, and the like and the horizontal thermal conductivity characteristics may be strengthened correspondingly (see FIG. 9).

To obtain the insulating characteristics, a functional material in a coating film form may be insulated by dissolving the same material as the polymer matrix 200 in a solvent and thus the thermal interface material may be mass-produced in a roll type.

When being applied to parts, the thermal interface material may be punched and tailored depending on the shape and the corner portion thereof may be provided with insulating characteristics by the spray coating method, and the like, using the same material and the insulating material. For the insulating method, the thermal interface material may be coated directly on the functional material or may be manufactured by the lamination method after the insulating film is manufactured.

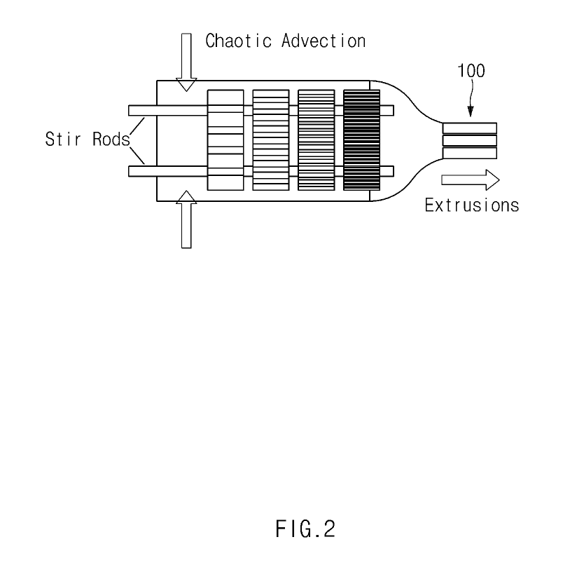

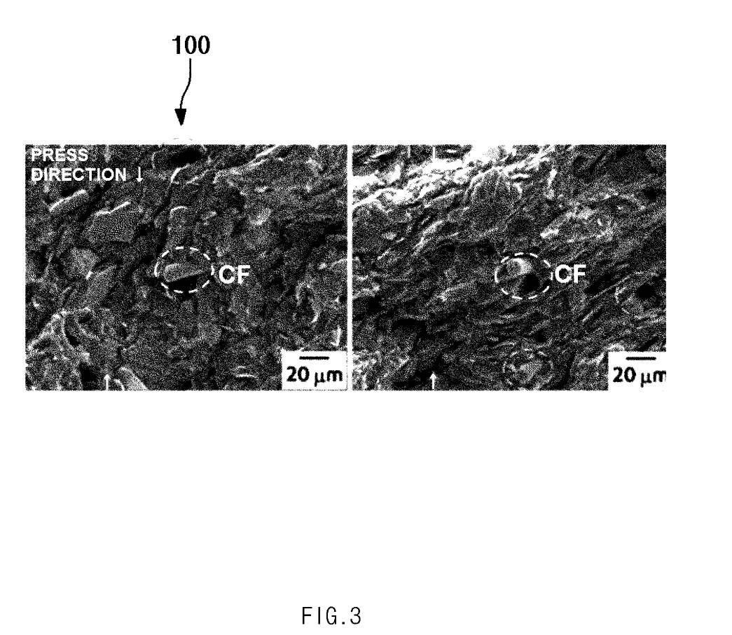

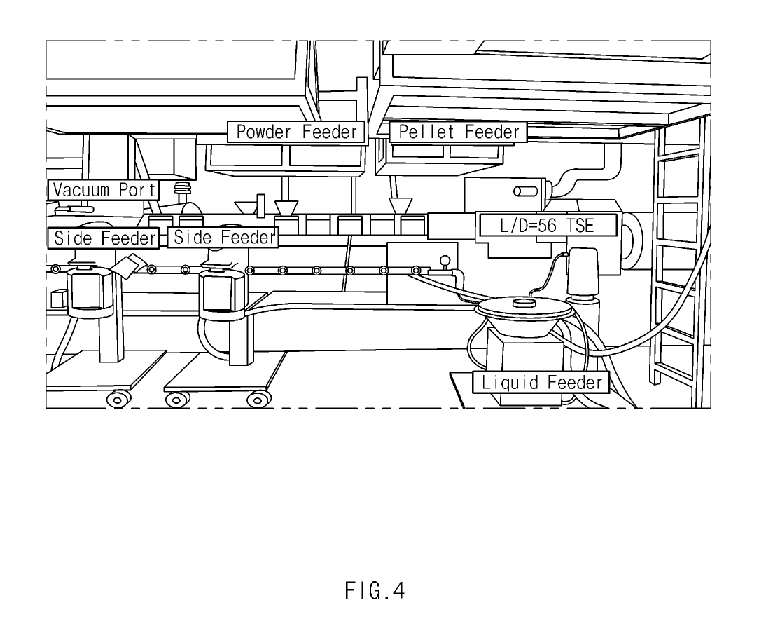

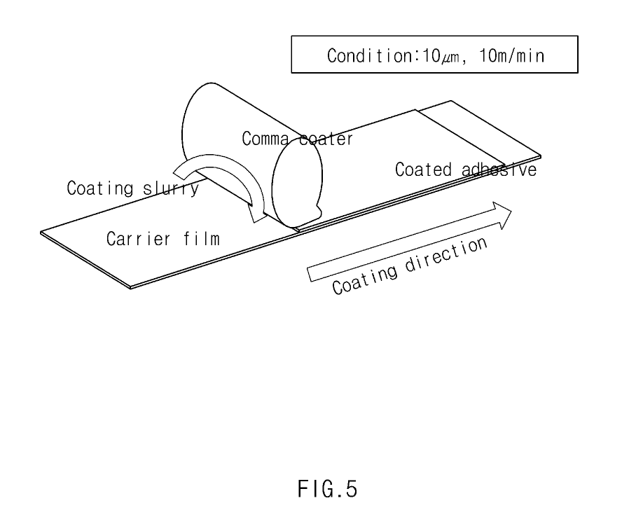

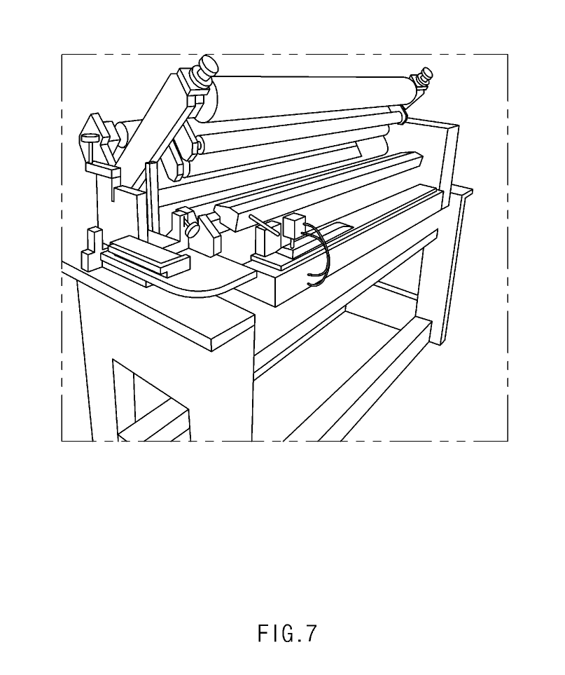

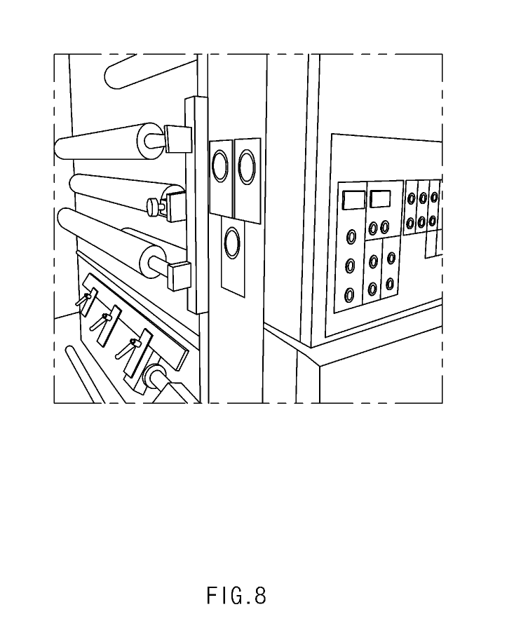

As illustrated in FIGS. 2 to 8, according to an exemplary embodiment of the present invention, to obtain the thin film type thermal interface material 300, the functional carbon filler 100 may be dissolved in a solvent and may be compressed to have a thickness from several about pm to about tens of pm, thereby manufacturing the thin film of the thermal conductive filler 100. In this case, as the solvent, the same material as the material of the polymer matrix 200 may be used. The thin film of the thermal conductive filler 100 may be coated with the polymer matrix 200 to have a thickness from several about pm to about tens of pm. Accordingly, the thermal conductive filler 100 having thermal conductivity may be formed as a functional layer and the polymer matrix 200 may be formed as an insulating layer to prevent a short between electronic parts in which the thermal interface material 300 is provided. Also, the surface sticking characteristics and the thermal conductivity characteristics may be optimized at the mounting portion by controlling the thickness of the functional layer and the insulating layer and the thermal interface material may be manufactured with the optimized thickness for applied parts.

Since the expensive filler 100 such as silver (Ag) and BN (boron nitride) is applied, the conventional thermal interface material 300 may be disadvantageous in costs. Moreover, the conventional thermal interface material 300 may be divided into a soft type and a hard type depending on the material of the polymer matrix 200 and needs to have different configurations depending on the type. However, the thermal interface material 300 according to an exemplary embodiment of the present invention may be configured in the soft type and the hard type depending on the thickness of the polymer matrix 200 as the insulating layer and the thermal conductive filler 100 as the functional layer and may be manufactured at a reduced price by about 30% to about 50%, as compared with the conventional thermal interface material.

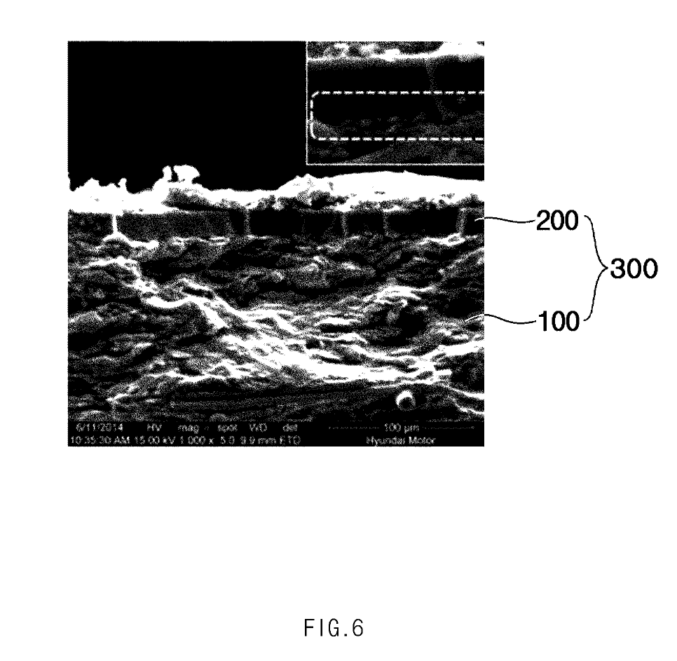

As illustrated in FIG. 6, the thermal interface material 300 manufactured by the manufacturing method according to an exemplary embodiment of the present invention may include the thermal conductive filler 100, the polymer matrix 200 that has an elastic force and is applied to the thermal conductive filler 100, and the insulating coating layer that is applied to the sides of the thermal conductive filler 100 and the polymer matrix 200.

As described above, the thermal conductive filler 100 may have a film shape and the polymer matrix 200 may be coated on the thermal conductive filler 100. According to an exemplary embodiment of the present invention, the insulating coating layer may be made of the same component as the polymer matrix 200.

Meanwhile, the thermal interface material 300 according to an exemplary embodiment of the present invention may be applied to the high heat radiation composite sheet. When the thermal interface material 300 is included in the high heat radiation composite sheet, heat generated from heat generation elements such as CPU or semiconductor may be conducted to a radiant heater due to the thermal conductive filler 100.

Further, anti-vibration performance and shock absorption performance which are required by the elastic force of the polymer matrix 200 may also be obtained. In this case, an electromagnetic wave shielding layer which may shield an electromagnetic wave may be installed in the high heat radiation composite sheet.

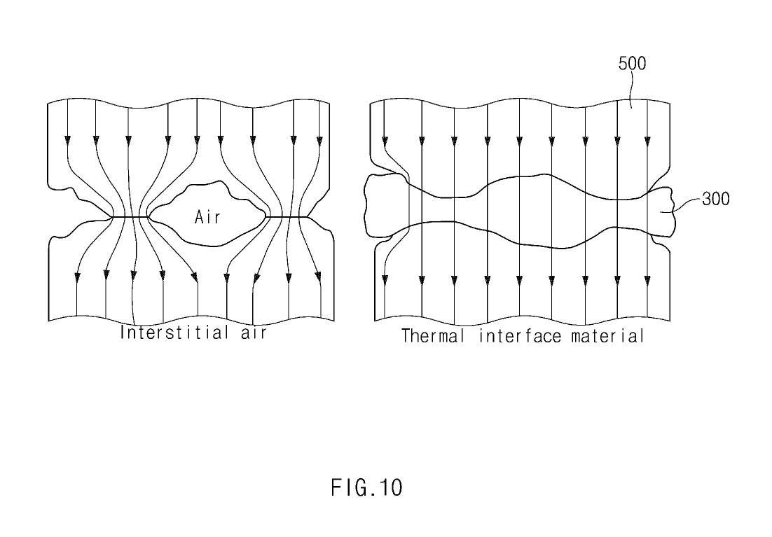

FIG. 10 illustrates heat movement by an arrow in the state in which the thermal interface material 300 manufactured by an exemplary manufacturing method according to an exemplary embodiment of the present invention is provided in a battery cell 500 in comparison to a state in which the thermal interface material is not equipped in the battery cell 500. According to the related art, a void is generated due to a relief of the attached surface, but since the polymer matrix 200 as the insulating layer may have the elastic force, the thermal interface material 300 manufactured by an exemplary manufacturing method according to an exemplary embodiment of the present invention may be pressed and thus the shape of the polymer matrix 200 may be deformed depending on the shape of the surface to which the thermal interface material 300 is attached and the presence of the void is prevented. As such, the void may not be generated between the thermal interface material 300 and the attached surface.

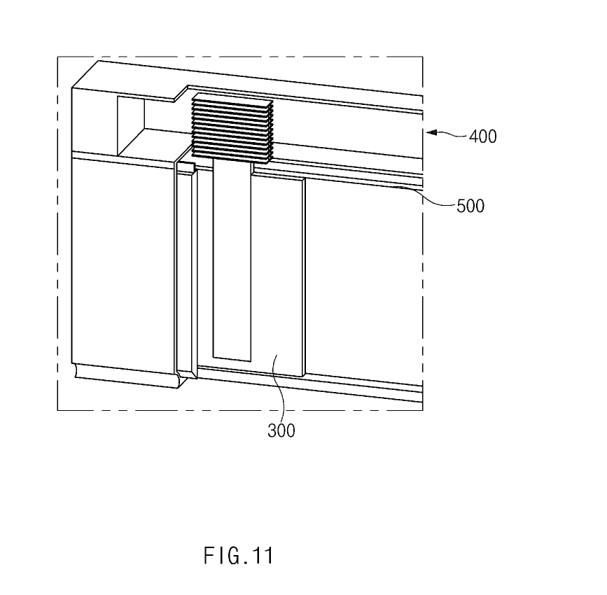

FIG. 11 illustrates a state in which the thermal interface material 300 manufactured by an exemplary manufacturing method according to an exemplary embodiment of the present invention is provided between the battery cells 500 thereby forming battery module 400. The thermal interface material 300 manufactured by an exemplary manufacturing method according to an exemplary embodiment of the present disclosure may be manufactured to be maximally slimmed depending on the required thermal conductivity. Depending on the characteristics, a distance between the battery cells 500 and the volume of the battery module 400 may be minimized.

As described above, according to various exemplary method for manufacturing a thermal interface material in accordance with exemplary embodiments of the present invention, the high heat radiation thermal interface material (a maximum of thermal conductivity of 20 W/mK) may be manufactured in more various thickness than the conventional thermal interface material (a maximum of thermal conductivity of 5 W/mK). Further, the thermal interface material depending on the shape of the applied part may be manufactured, the thermal interface material may be produced in the roll type, and mass-production of the thermal interface material may be obtained.

Further, since the elastomer material having an elastic force is used as the polymer matrix, the surface sticking characteristics may be maximized, when the elastomer material is produced in the roll type, the elastomer material may be tailored and punched to meet a change in applied parts so as to increase the shape freedom, and the corner portions of the material may secure the insulating characteristics using the spray method, and the like. In this case, the risk of electrical short may be removed and costs may be reduced such as, e.g. by about 30 to 50% relative to conventional methods.

Hereinabove, although the present disclosure has been described with reference to exemplary embodiments and the accompanying drawings, the present invention is not limited thereto, but may be variously modified and altered by those skilled in the art to which the present invention pertains without departing from the spirit and scope of the present disclosure claimed in the following claims.

What is claimed is:

1. A method for manufacturing a thermal interface material that includes a thermal conductive filler, a polymer matrix having an elastic force and applied to the thermal conductive filler, and an insulating coating layer applied to sides of the thermal conductive filler and the polymer matrix, comprising:
providing the thermal conductive filler in a plate film form; and
coating the thermal conductive filler in the plate film form with the polymer matrix,
wherein the thermal conductive filler is formed by dissolving a filler material in a solvent.

2. The method according to claim 1, wherein the thermal conductive filler is provided by extruding.

3. The method according to claim 1, further comprising:
forming the insulating coating layer by spraying a liquid having the same component as the polymer matrix on the sides of the polymer matrix and the thermal conductive filler.

4. The method according to claim 1, wherein the polymer matrix is made of any one of styrene-based thermoplastic elastomer (TPE), olefin-based thermoplastic elastomer, polyester-based thermoplastic elastomer, and polyamide-based thermoplastic elastomer.

5. The method according to claim 1, wherein the polymer matrix is made of any one of styrene-butadiene-styrene (SBS) block copolymer, styrene-butadiene-ethylene-styrene (SBES) block copolymer, styrene-isoprene-styrene block copolymer (SIS).

6. The method according to claim 1, wherein the thermal conductive filler comprises at least one of carbon black, graphite, expanded graphite granule (EGG), graphene and grahphne oxide.

7. The method according to claim 6, wherein thermal conductive filler is contained at a content of about 20-65 wt %, based on the total weight of the thermal interface material.

8. The method according to claim 6, wherein thermal conductive filler further includes any one selected from the group consisting of carbon nanotube(CNT) and carbon fiber(CF).

9. The method according to claim 8, wherein the CNT or the CF may be contained at a content of about 0-20 wt %, based on the total weight of the thermal interface material.

10. The method according to claim 8, wherein the CNT or the CF is embedded in the thermal conductive filler to provide directivity.

11. The method according to claim 1, wherein the solvent is a same component of the polymer matrix.

12. A thermal interface material, comprising:
a thermal conductive filler;
a polymer matrix configured to have an elastic force and applied to the thermal conductive filler; and
an insulating coating layer applied to sides of the thermal conductive filler and the polymer matrix.

13. The thermal interface material according to claim 12, wherein the thermal conductive filler is formed in a film shape and the polymer matrix is coated on the thermal conductive filler.

14. The thermal interface material according to claim 12, wherein the insulating coating layer is made of the same component as the polymer matrix.

15. The thermal interface material according to claim 9, wherein the thermal conductive filler comprises at least one of carbon black, graphite, and expanded graphite granule (EGG), graphene and grahphne oxide.

16. The thermal interface material according to claim 15, wherein thermal conductive filler is contained at a content of about 20-65 wt %, based on the total weight of the thermal interface material.

17. The thermal interface material according to claim 15, wherein thermal conductive filler further includes any one selected from the group consisting of carbon nanotube(CNT) and carbon fiber(CF).

18. The thermal interface material according to claim 17, wherein the CNT or the CF may be contained at a content of about 0-20 wt %, based on the total weight of the thermal interface material.

19. A high heat radiation composite sheet including a thermal interface material including a thermal conductive filler and a polymer matrix coated on the thermal conductive filler.
